(19) United States
(12) Patent Application Publication
(10) Pub. No.: US 2026/0122298 A1
(43) Pub. Date: Apr. 30, 2026

(54) DISPLAY DEVICE AND OPERATING METHOD OF THE SAME

(71) Applicant: Samsung Electronics Co., Ltd., Suwon-si (KR)

(72) Inventors: Juneho LEE, Suwon-si (KR); Youngsang SHIN, Suwon-si (KR); Taehyun KIM, Suwon-si (KR); Hyunjune LIM, Suwon-si (KR)

(21) Appl. No.: 19/384,801

(22) Filed: Nov. 10, 2025

Related U.S. Application Data
(63) Continuation of application No. PCT/KR2025/014442, filed on Sep. 17, 2025.

(30) Foreign Application Priority Data
Oct. 25, 2024 (KR) 10-2024-0147908

(51) Int. Cl. H04N 21/258; H04N 21/24; H04N 21/485

(52) U.S. Cl. CPC H04N 21/25825; H04N 21/2407; H04N 21/485

(57) ABSTRACT

A display device includes a communicator comprising communication circuitry configured to communicate with one or more remote servers, a memory storing one or more instructions, and at least one processor comprising processing circuitry, wherein at least one processor, individually and/or collectively, is configured to execute the one or more instructions and to cause the display device to: receive a control command for at least one resource of the display device from the one or more remote servers, execute the control command, based on a control policy for the resource, and transmit state information of the resource to the remote servers, based on a change in state of the resource as a result of executing the control command.

### CROSS-REFERENCE TO RELATED APPLICATIONS

This application is a continuation of International Application No. PCT/KR2025/014442 designating the United States, filed on Sep. 17, 2025, in the Korean Intellectual Property Receiving Office and claiming priority to Korean Patent Application No. 10-2024-0147908, filed on Oct. 25, 2024, in the Korean Intellectual Property Office, the disclosures of each of which are incorporated by reference herein in their entireties.

### BACKGROUND

### Field

The disclosure relates to a display device controlled by a plurality of remote servers and an operating method of the display device.

### Description of Related Art

With the technological advancement of display devices, display devices that are able to implement various functions are being developed. A television (TV) may be a prime example of a display device. The traditional TV simply receives a broadcast signal and performs a function to play corresponding broadcast content (e.g., news, dramas, entertainment shows, etc.). Due to the recent technological advancement of display devices, various applications or programs for the TV to perform the various functions may be stored and installed in the TV, and the TV may provide various functions and services in addition to the broadcast content replay function through the installed application.

The display device may also be used in a signage form commonly used for the purpose of delivering or guiding information. Signage may be installed in various places such as public places, commercial places, companies, educational institutions, transportation facilities, etc. For example, signage may display flight or train departure times at airports or train stations, be used to advertise products or services in commercial space, or update advertising content in real time.

A display device such as signage may be controlled by a remote server. In a case where a plurality of remote servers simultaneously control one display device, control commands from the plurality of remote servers may collide with each other, or a control command performed by one of the plurality of servers may not be recognized by other servers.

### SUMMARY

According to an example embodiment, a display device may include: a communicator comprising communication circuitry configured to communicate with one or more remote servers, a memory storing one or more instructions, and at least one processor comprising processing circuitry, wherein at least one processor, individually and/or collectively, is configured to execute the one or more instructions and to cause the display device to: receive a control command for at least one resource of the display device from the one or more remote servers; execute the control command based on a control policy for the resource; and transmit state information of the resource to the remote servers, based on a change in state of the resource as a result of executing the control command.

According to an example embodiment, a method of operating a display device may include: receiving a control command for at least one resource of the display device from one or more remote servers; executing the control command based on a control policy for the resource; and transmitting state information of the resource to the remote servers, based on a change in state of the resource as a result of executing the control command.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a diagram illustrating an example display device according to various embodiments;

FIG. 2 is a diagram illustrating an example configuration of a display device according to various embodiments;

FIG. 3 is a flowchart illustrating an example operation of a display device, according to various embodiments;

FIG. 4 is a diagram illustrating an example control policy according to various embodiments;

FIGS. 5 and 6 include a diagram and a signal flow diagram illustrating example operations of a display device when a control policy for a resource is set to a full permission mode, according to various embodiments;

FIGS. 7 and 8 include a diagram and a signal flow diagram illustrating example operations performed when a control policy for a resource is set to a master mode, according to various embodiments;

FIGS. 9 and 10 include a diagram and a signal flow diagram illustrating example operations performed when a control policy for a resource is set to a master mode, according to various embodiments;

FIGS. 11, 12, 13, 14, 15, 16 and 17 include diagrams and signal flow diagrams illustrating example operations performed when a control policy for a resource is set to a security reinforcement mode, according to various embodiments;

FIG. 18 is a diagram illustrating an example user interface screen for establishing a resource control policy, according to various embodiments;

FIG. 19 is a block diagram illustrating an example configuration of a display device according to various embodiments; and

FIG. 20 is a block diagram illustrating an example configuration of a display apparatus according to various embodiments.

### DETAILED DESCRIPTION

Terms as used herein will be described and various example embodiments of the disclosure will be described in greater detail.

The terms are selected as common terms currently widely used, taking into account functions in the disclosure, which may however depend on intentions of ordinary people in the art, judicial precedents, emergence of new technologies, and the like. Some terms as herein used may be arbitrarily selected, in which case, the meaning will be explained in detail in the description of the disclosure. Therefore, the terms should be defined based on their meanings and descriptions throughout the disclosure.

The term “include (or including)” or “comprise (or comprising)” is inclusive or open-ended and does not exclude additional, unrecited elements or method steps. The terms “unit”, “module”, “block”, etc., as used herein each represent a unit for handling at least one function or operation, and may be implemented in hardware, software, or a combination thereof.

Embodiments of the disclosure will now be described in greater detail with reference to accompanying drawings. However, the various example embodiments of the disclosure may be implemented in many different forms, and are not limited to those discussed herein. In the drawings, parts unrelated to the description may be omitted for clarity, and like numerals refer to like elements throughout the disclosure.

In various embodiments of the disclosure, the term ‘user’ may refer to a person who controls a system, a function or an operation, including a developer, an administrator, or an installation engineer.

Furthermore, in various embodiments of the disclosure, the term ‘image’ or ‘picture’ may refer to a still image, a moving image comprised of a plurality of successive still images (or frames) or a video.

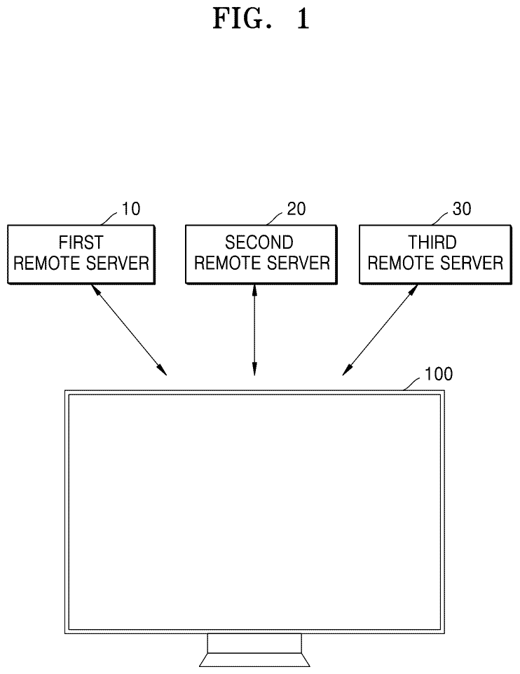

FIG. 1 is a diagram illustrating an example display device, according to various embodiments.

Referring to FIG. 1, a display device 100 according to an embodiment may be a television (TV), but it is merely an example and may be implemented in various forms including a display. For example, the display device 100 may be implemented in various forms such as a cell phone, a tablet personal computer (PC), a digital camera, a camcorder, a laptop computer, a desktop, an electric book terminal, a digital broadcasting terminal, a personal digital assistant (PDA), a portable multimedia player (PMP), a navigation system, an MP3 player, a wearable device, etc.

In an embodiment, the display device 100 may be implemented as signage. The signage may include a visual display device used for information delivery. The signage may be installed in various forms at public places, commercial facilities, companies, schools, etc., and used to deliver advertisements, instructions, warnings or other information.

The display device 100 may also be a stationary electronic device placed in a fixed position, a mobile electronic device having a portable form, or a digital broadcast receiver capable of receiving digital broadcasting.

The display device 100 may be implemented not only as a flat display device but also as a curved display device having a curved screen or a flexible display device with adjustable curvature. The output resolution of the display device 100 may include, for example, high definition (HD), full HD, ultra HD or a resolution higher than ultra HD.

In an embodiment, the display device 100 may communicate with a plurality of remote servers. In an embodiment, the plurality of remote servers may include a first remote server 10, a second remote server 20 and a third remote server 30, without being limited thereto.

The display device 100 may communicate with the plurality of remote servers 10, 20 and 30 based on various communication protocols. For example, the display device 100 may communicate with the plurality of remote servers 10, 20 and 30 based on various communication protocols such as a Wi-Fi scheme, a Bluetooth scheme, Zigbee, 3rd generation (3G), 3rd generation partnership project (3GPP), long term evolution (LTE), LTE advanced (LTE-A), 4th generation (4G), 5th generation (5G), etc. It is not, however, limited thereto.

In an embodiment, the plurality of remote servers 10, 20 and 30 may control a resource of the display device 100. For example, the plurality of remote servers 10, 20 and 30 may transmit, to the display device 100, control commands to control the resource of the display device 100.

In an embodiment, the resource of the display device 100 may include functions or states provided by the display device 100. For example, the resource of the display device 100 may include network setting, image quality setting of the display device 100, audio setting of the display device 100, a USB lock/unlock function of the display device 100, a Wi-Fi lock/unlock function of the display device 100, a Bluetooth lock/unlock function of the display device 100, a rebooting function, a volume control function, etc. It is not, however, limited thereto.

For example, when the first remote server 10 transmits a USB unlock command to the display device 100, the display device 100 may execute the USB unlock command and a USB of the display device 100 is unlocked. When the second remote server 20 transmits a USB lock command to the display device 100, the display device 100 may execute the USB lock command and the USB of the display device 100 is locked. The first remote server 10 is unable to know that the USB has been changed into the locked state, and may consider that the USB of the display device 100 is unlocked and transmit a USB file read command to the display device 100. However, the USB of the display device 100 is in the locked state, so the display device 100 is unable to execute the USB file read command received from the first remote server 10 (command failure).

Thus, when a resource of the display device 100 is controlled by the plurality of remote servers 10, 20 and 30, a state of the resource of the display device 100 needs to be shared by the plurality of remote servers 10, 20 and 30.

To mediate between control commands received from the plurality of remote servers 10, 20 and 30, a control policy for the resource is required, and the display device 100 may or may not execute the control commands received from the plurality of remote servers 10, 20 and 30 based on the control policy.

Operations of processing the control commands received from the plurality of remote servers 10, 20 and 30 according to the control policy established by the display device 100 according to various embodiments will be described in greater detail below.

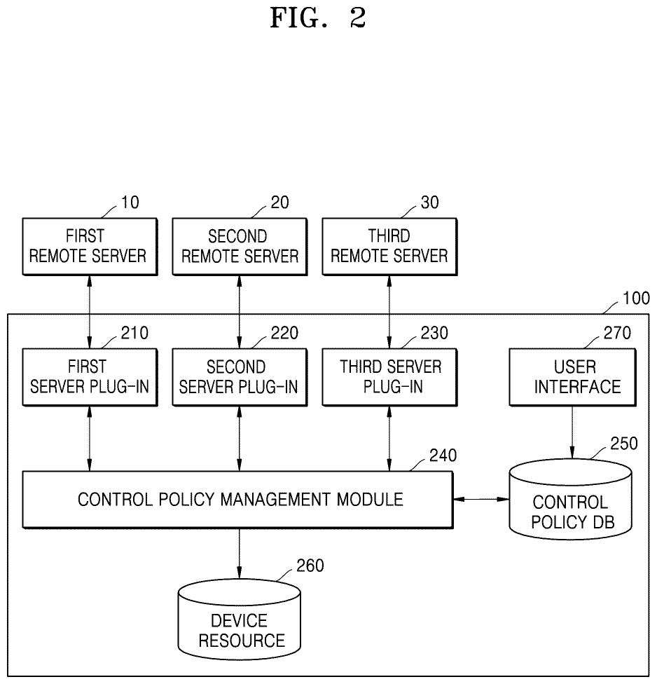

FIG. 2 is a diagram illustrating an example configuration of a display device, according to various embodiments.

Referring to FIG. 2, the display device 100 in the example may include a first server plug-in 210, a second server plug-in 220, a third server plug-in 230, each plug in comprising various circuitry and/or executable program instructions, a control policy management module (e.g., including various circuitry and/or executable program instructions) 240, a device resource (e.g., including various circuitry and/or executable program instructions) 260, a control policy database (DB) 250, and a user interface (e.g., including various circuitry) 270.

In an embodiment, the display device 100 may receive control commands for the resource of the display device 100 from the plurality of remote servers. For example, the plurality of remote servers may include the first remote server 10, the second remote server 20 and the third remote server 30. It is not, however, limited thereto. The display device 100 may receive resource control commands from the first remote server 10, the second remote server 20 and the third remote server 30.

In an embodiment, the first remote server 10 and the first server plug-in 210 may communicate with each other according to a first protocol. For example, the first remote server 10 may transmit a first control command to the first server plug-in 210 according to the first protocol. The first server plug-in 210 may receive the first control command from the first remote server 10 according to the first protocol. The first server plug-in 210 may transmit or forward the first control command to the control policy management module 240.

In an embodiment, the second remote server 20 and the second server plug-in 220 may communicate with each other according to a second protocol. For example, the second remote server 20 may transmit a second control command to the second server plug-in 220 according to the second protocol. The second server plug-in 220 may receive the second control command from the second remote server according to the second protocol. The second server plug-in 22 may transmit or forward the second control command to the control policy management module 240.

In an embodiment, the third remote server 30 and the third server plug-in 230 may communicate with each other according to a third protocol. For example, the third remote server 30 may transmit a third control command to the third server plug-in 230 according to the third protocol. The third server plug-in 230 may receive the third control command from the third remote server 30 according to the third protocol. The third server plug-in 230 may transmit or forward the third control command to the control policy management module 240.

The control policy management module 240 may include a device or module including various circuitry and/or executable program instructions for processing the control commands received from the remote servers 10, 20 and 30 based on the control policy according to an embodiment. The control policy management module 240 may include an appropriate logic, circuit, interface and/or code that may be operated to process the control command based on the established control policy.

It may determine whether to execute the first control command received from the first server plug-in 210, the second control command received from the second server plug-in 220 and the third control command received from the third server plug-in 230.

In an embodiment, the control policy DB 250 may store information regarding the control policy for the resource. Furthermore, the control policy stored in the control policy DB 250 may be established, modified, added or deleted based on a user input. In an embodiment, the user interface 270 may receive a user input to establish, modify, add or delete the control policy stored in the control policy DB 250.

The control policy management module 240 may send a request or inquiry for information regarding the control policy to the control policy DB 250. The control policy management module 240 may receive information regarding the control policy from the control policy DB 250, and determine whether to execute the first control command, the second control command and the third control command according to the control policy. Furthermore, the control policy management module 240 may send a request or inquiry for state information of the device resource to the control policy DB 250.

The control policy management module 240 may receive the state information of the device resource from the control policy DB 250, and when there is a change in state of the resource due to execution of the control command, it may transmit changed state information of the resource to the control policy DB 250 to update the state information of the resource stored in the control policy DB 250.

When it is determined that the first control command is to be executed according to the control policy, the control policy management module 240 executes the first control command for the device resource. For example, the first control command may be a lock command for a USB, and the control policy management module 240 may lock the USB that has been unlocked.

In an embodiment, when the state of the resource is changed as a result of executing the control command, the control policy management module 240 may notify the change in state of the resource to the remote servers 10, 20 and 30. For example, when the state of the USB is changed from the unlocked state to the locked state, the control policy management module 240 may transmit resource state change information to the plurality of server plug-ins 210, 220 and 230. Each of the plurality of server plug-ins 210, 220 and 230 may transmit the resource state change information to the remote server 10, 20 or 30 according to a protocol. For example, the first server plug-in 210 may transmit the resource state change information to the first remote server 10 according to the first protocol.

The second server plug-in 220 may transmit the resource state change information to the second remote server 20 according to the second protocol. The third server plug-in 230 may transmit the resource state change information to the third remote server 30 according to the third protocol.

Accordingly, when the state of the resource is changed according to the first control command received from the first remote server 10, the second remote server 20 and the third remote server 30 may also recognize the change in state of the resource.

Furthermore, when it is determined that the second control command is to be executed according to the control policy, the control policy management module 240 executes the second control command for the device resource 260. For example, the second control command may be an unlock command for the USB, and the control policy management module 240 may unlock the USB. When the state of the USB is changed from the locked state to the unlocked state as a result of executing the control command, the control policy management module 240 may notify the changed state information of the USB to the remote servers 10, 20 and 30.

When it is determined that the third control command is to be executed according to the control policy, the control policy management module 240 may execute the third control command for the device resource 260. For example, the third control command may be an unlock command for Bluetooth, the control policy management module 240 may unlock the Bluetooth. When the state of the Bluetooth is changed from the locked state to the unlocked state as a result of executing the control command, the control policy management module 240 may notify the changed state information of the Bluetooth to the remote servers 10, 20 and 30.

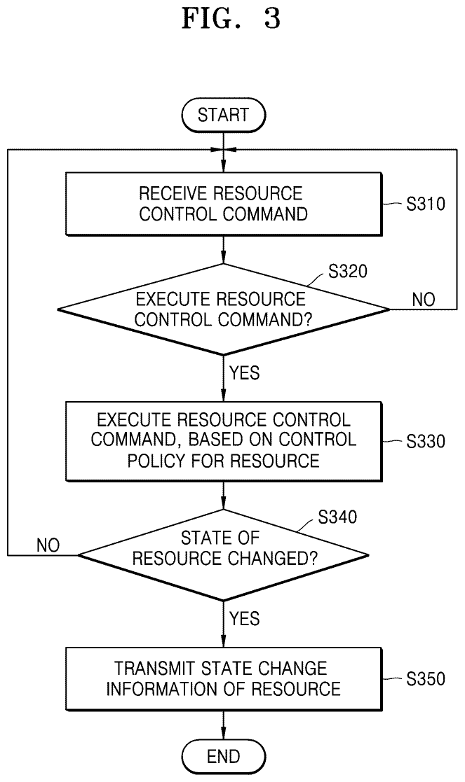

FIG. 3 is a flowchart illustrating an example operation of a display device, according to various embodiments.

Referring to FIG. 3, the display device 100 in an embodiment may receive a control command for a resource, in S310.

For example, the display device 100 may receive a control command from at least one of the plurality of remote servers connected to the display device 100. When receiving control commands from the plurality of remote servers, the display device 100 may process the control commands in the order of receiving the control commands. It is not, however, limited thereto.

The display device 100 may receive a control command through a server plug-in corresponding to each of the plurality of remote servers. The server plug-in may receive the control command according to a communication protocol with the remote server to communicate with.

In an embodiment, the display device 100 may determine whether to execute a control command for the resource based on the control policy for the resource, in S320.

In an embodiment, the control policy for the resource may include information about a control mode set for each resource, information about a master server when the control mode is a master mode, information about a range of resources controllable by each remote server, information about a security reinforcement mode, etc.

For example, when the control mode for the first resource is a full permission mode, all the remote servers are able to control the first resource. The display device 100 may execute the control commands received from the remote servers, and the state of the first resource may be changed accordingly.

When the control mode for the second resource is a master mode, the display device 100 may inquire a remote server designated as a master server about whether to execute a control command for the second resource received from a remote server that is not the master server. The display device 100 may determine whether to execute the control command according to a response from the master server.

In a case that the control mode for the third resource is a security reinforcement mode, when a control command for the third resource received from a remote server is a command to disable the third resource, the display device 100 may determine to execute the control command. On the other hand, when the control command for the third resource is a command to enable the third resource, it may determine whether to perform execution according to control commands received from the other remote servers. For example, when all the control commands received from the other remote servers are also a command to enable the third resource, it may determine to execute the control command.

In an embodiment, when determining to execute the control command, the display device 100 may execute the control command S330.

In an embodiment, when the state of the resource is changed as a result of executing the control command in S340, the display device 100 may transmit state change information of the resource to the remote servers in S350.

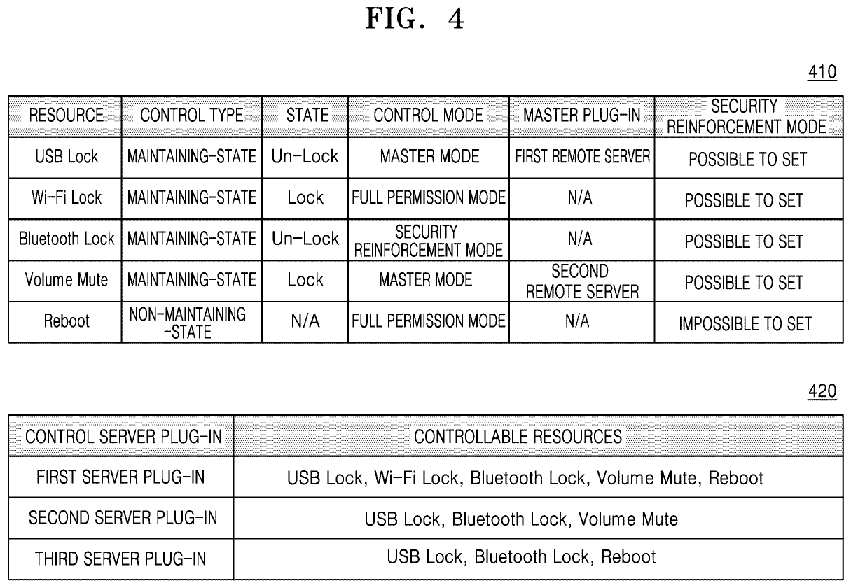

FIG. 4 is a diagram illustrating an example control policy, according to various embodiments.

Referring to FIG. 4, in an embodiment, the control policy may include information 410 regarding whether to set a security reinforcement mode, a control type of the resource, a state of the resource, a control mode for the resource, information about a master server when the control mode is a master mode, etc.

In an embodiment, the resource may include functions or states provided by the display device 100. For example, the resource of the display device 100 may include network setting, image quality setting of the display device 100, audio setting of the display device 100, a USB lock/unlock function of the display device 100, a Wi-Fi lock/unlock function of the display device 100, a Bluetooth lock/unlock function of the display device 100, a rebooting function, a volume control function, etc. It is not, however, limited thereto.

In an embodiment, a control policy 410 for a resource may include information about a control type of the resource. The control type of the resource may indicate whether the state of the resource needs to be maintained. For example, when the control type is maintaining-state, the state of the resource needs to be maintained, and when the control type is not-maintaining-state, the state of the resource does not have to be maintained. For example, in the case of USB lock or unlock, when the USB is locked or unlocked by executing the control command, it is a resource whose state needs to be maintained and the control type may be the maintaining-state. On the other hand, in the case of rebooting, when rebooting is performed by executing the command, it is a resource whose state does not have to be maintained, and the control type may be the non-maintaining-state.

In an embodiment, the control policy for a resource may include information indicating a current state of the resource.

In an embodiment, the control policy for the resource may include information about a control mode of the resource. The control mode of the resource may include a full permission mode, a master mode and a security reinforcement mode.

For example, the full permission mode may refer to a mode that allows the resource to be controlled by all the remote servers. The master mode may refer to a mode in which one of the remote servers is designated as a master server and the master server determines whether to execute a control command when the control command for the resource is received from other remote servers than the master server. When the control mode for the resource is the master mode, the control policy may include information about the master server.

The security reinforcement mode may refer to a mode that prioritizes a control command to disable the resource over a control command to enable the resource. For example, in the security reinforcement mode, when a control command for the resource is a command to disable the resource, the command may be executed. On the other hand, when the control command for the resource is a command to enable the resource, the control command may be executed only when all control commands received from other remote servers are to enable the resource.

In an embodiment, the control policy 410 may include information about whether it is possible to set the security reinforcement mode. For example, for a resource for which the enabled state and the disabled state are not defined, it may not be possible to set the security reinforcement mode. For example, in the case of rebooting, it is not possible to set the security reinforcement mode. It is not, however, limited thereto.

In an embodiment, the control policy may include information 420 about a range of resources that may be controlled by each remote server. For example, the first remote server may control the USB lock/unlock function of the display device 100, the Wi-Fi lock/unlock function of the display device 100, the Bluetooth lock/unlock function of the display device 100, the volume control function, and the rebooting function; the second remote server may control the USB lock/unlock function of the display device 100, the Bluetooth lock/unlock function of the display device 100, and the volume control function; the third remote server may control the USB lock/unlock function of the display device 100, the Bluetooth lock/unlock function of the display device 100, and the rebooting function.

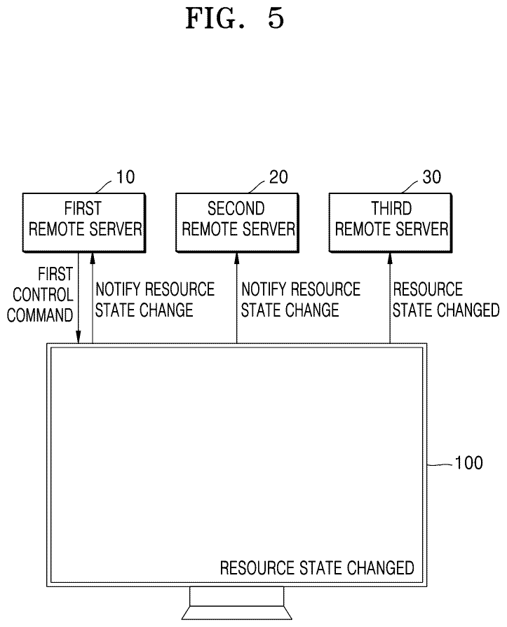

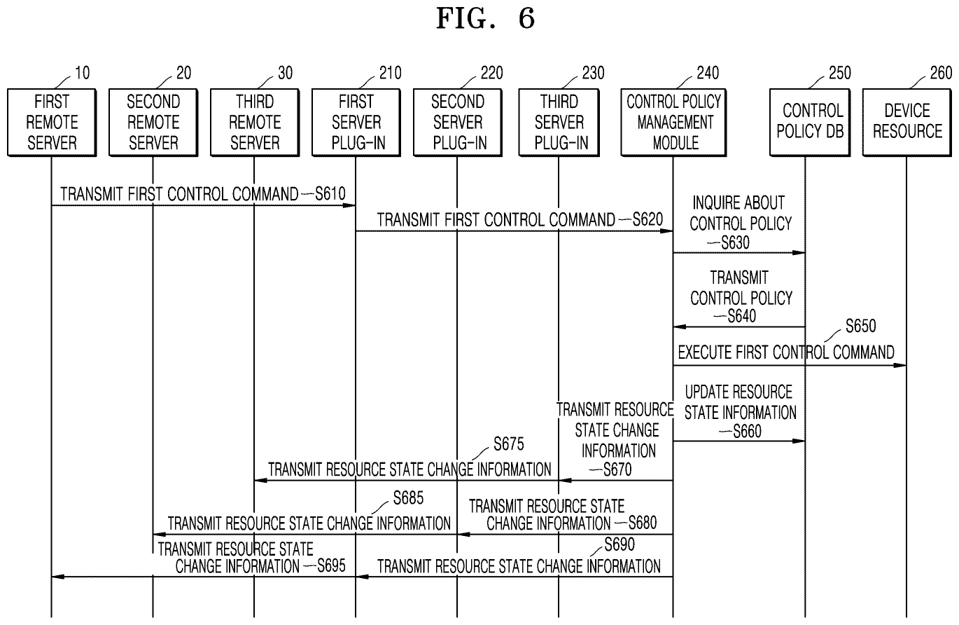

FIGS. 5 and 6 include a diagram and signal flow diagram illustrating example operations when a control policy for a resource is set to a full permission mode, according to various embodiments.

In an embodiment, a control policy for a first resource may be set to the full permission mode.

Referring to FIG. 5, in an embodiment, the display device 100 may receive a first control command for the first resource from the first remote server 10. The display device 100 may execute the first control command for the first resource based on the control policy for the first resource being the full permission mode.

Based on a change in state of the first resource due to execution of the first control command for the first resource, the display device 100 may transmit state change information of the first resource to the first to third remote servers 10, 20 and 30.

FIG. 6 illustrates operations of FIG. 5 in greater detail.

Referring to FIG. 6, the first remote server 10 may transmit the first control command for the first resource to the first server plug-in 210 according to the first protocol, in S610. The first server plug-in 210 may receive the first control command for the first resource from the first remote server 10 according to the first protocol. In this case, the first resource may indicate a USB lock/unlock function, and the first control command may be a USB lock command.

The first server plug-in 210 may transmit the first control command to the control policy management module 240, in S620.

The control policy management module 240 may send a request or inquiry for a control policy for the first resource to the control policy DB 250, in S630. The control policy DB 250 may send or forward information about the control policy for the first resource to the control policy management module 240, in S640.

The control policy management module 240 may determine whether to execute the first control command based on the control policy for the first resource. In this case, the control mode for the first resource may be the full permission mode, and the first resource may be included in the range of resources controllable by the first remote server.

The control policy management module 240 may execute the first control command for the first resource in S650, and update state information of the first resource stored in the control policy DB in S660 by transmitting state change information of the first resource to the control policy DB 250 when the state of the first resource is changed as a result of executing the first control command for the first resource. For example, when the USB is changed from the unlocked state into the locked state as a result of executing the first control command, the control policy management module 240 may update the state of the USB stored in the control policy DB to locked from unlocked.

The control policy management module 240 may notify the change in state of the first resource to the first to third remote servers 10, 20 and 30. For example, the control policy management module 240 may transmit the state change information of the first resource (locked state of the USB) to the first server plug-in 210, the second server plug-in 220 and the third server plug-in, in S670, S680 and S690. The first server plug-in 210 may transmit the state change information of the first resource to the first remote server 10 according to the first protocol, in S695. The second server plug-in 220 may transmit the state change information of the first resource to the second remote server 20 according to the second protocol, S685. The third server plug-in 230 may transmit the state change information of the first resource to the third remote server 30 according to the third protocol, S675.

Accordingly, the change in state of the resource due to execution of the first control command received from the first remote server 10 may also be recognized by the other remote servers (the second remote server 20 and the third remote server 30), thereby increasing reliability of remote control environments.

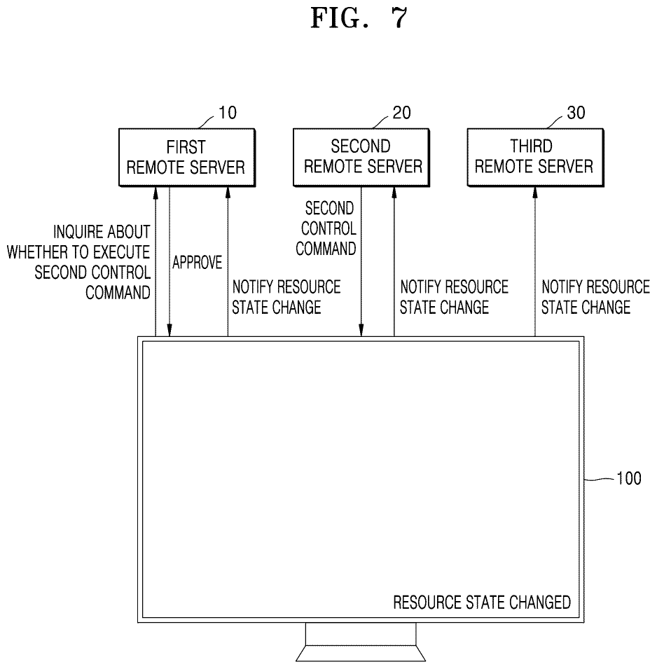

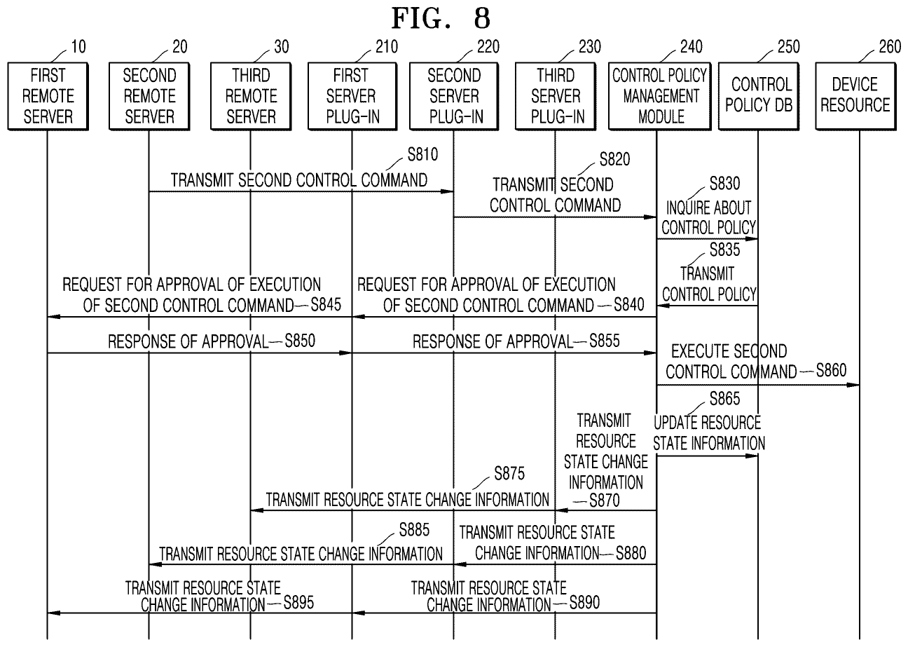

FIGS. 7 and 8 include a diagram and a signal flow diagram illustrating example operations when a control policy for a resource is set to a master mode, according to various embodiments.

In an embodiment, a control policy for the second resource may be set to a master mode, and the first remote server 10 may be designated as a master server.

Referring to FIG. 7, in an embodiment, the display device 100 may receive a second control command for the second resource from the second remote server 20. Based on the control policy for the second resource being the master mode, the display device 100 may transmit a request to approve execution of the second control command for the second resource to the first remote server 10.

The first remote server 10 may transmit a response of approving the second control command to the display device 100, and execute the second control command based on the response of approving the second control command.

Based on a change in state of the second resource due to execution of the second control command for the second resource, the display device 100 may transmit state change information of the second resource to the first to third remote servers 10, 20 and 30.

FIG. 8 illustrates operations of FIG. 7 in greater detail.

Referring to FIG. 8, the second remote server 20 may transmit the second control command for the second resource to the second server plug-in 220 according to the second protocol, in S810. The second server plug-in 220 may receive the second control command for the second resource from the second remote server 20 according to the second protocol. The second server plug-in 220 may transmit the second control command for the second resource to the control policy management module 240, in S820. In this case, the second resource may indicate the Bluetooth lock/unlock function, and the second control command may be the Bluetooth lock command.

The control policy management module 240 may send a request or inquiry for a control policy for the second resource to the control policy DB 250, in S830. The control policy DB 250 may send or forward information about the control policy for the second resource to the control policy management module 240, in S835.

Based on the control policy for the second resource being the master mode and the master server being the first remote server 10, the control policy management module 240 may transmit a request to approve the second control command to the first server plug-in 210, in S840. The first server plug-in 210 may transmit the request to approve the second control command to the first remote server 10 according to the first protocol in S845, and the first remote server 10 may transmit a response to the request to approve the second control command to the first server plug-in 210 according to the first protocol in S850. The first server plug-in 210 may forward the response of the first remote server 10 to the control policy management module 240, in S855. In this case, when the response is about approving the second control command, the control policy management module 240 may execute the second control command for the second resource in S860. When the state of the second resource is changed as a result of executing the second control command for the second resource, the state change information of the second resource may be transmitted to the control policy DB 250, thereby updating the state information of the second resource stored in the control policy DB 250, in S865. For example, when the Bluetooth is changed from the unlocked state into the locked state as a result of executing the second control command, the control policy management module 240 may update the state of the Bluetooth stored in the control policy DB to locked from unlocked.

The control policy management module 240 may notify the change in state of the second resource to the first to third remote servers 10, 20 and 30. For example, the control policy management module 240 may transmit the state change information of the second resource (locked state of the Bluetooth) to the first server plug-in 210, the second server plug-in 220 and the third server plug-in, in S870, S880 and S890. The first server plug-in 210 may transmit the state change information of the second resource to the first remote server 10 according to the first protocol, in S895. The second server plug-in 220 may transmit the state change information of the second resource to the second remote server 20 according to the second protocol, S885. The third server plug-in 230 may transmit the state change information of the second resource to the third remote server 30 according to the third protocol, S875.

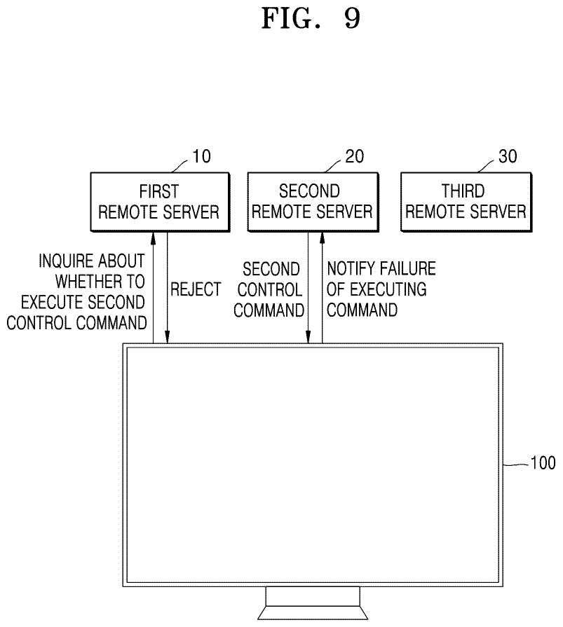

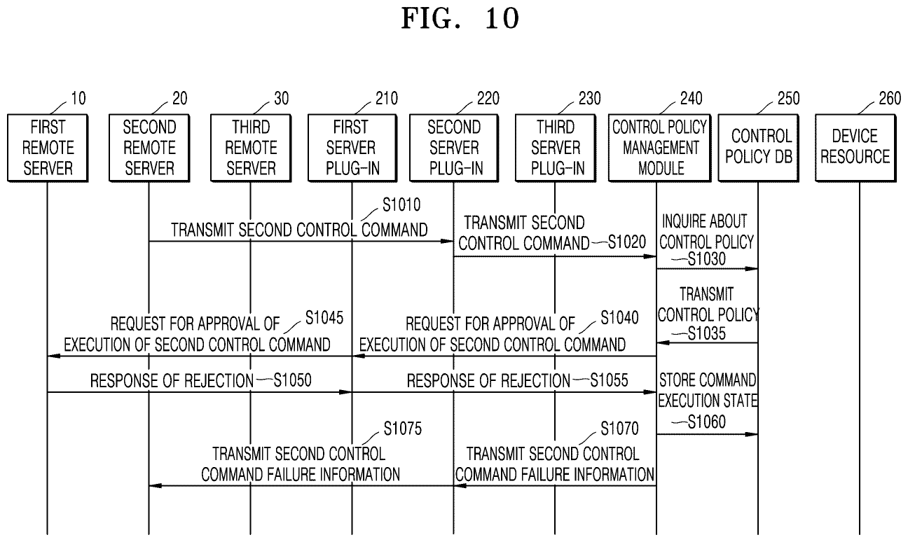

FIGS. 9 and 10 include a diagram and signal flow diagram illustrating example operations when a control policy for a resource is set to a master mode, according to various embodiments.

In an embodiment, a control policy for the second resource may be set to a master mode, and the first remote server 10 may be designated as a master server.

Referring to FIG. 9, in an embodiment, the display device 100 may receive a second control command for the second resource from the second remote server 20. Based on the control policy for the second resource being the master mode, the display device 100 may transmit a request to approve execution of the second control command for the second resource to the first remote server 10.

The first remote server 10 may transmit a response of rejecting the second control command to the display device 100, and may not execute the second control command based on the response of rejecting the second control command.

The display device 100 may not execute the second control command for the second resource, and may transmit information indicating a failure of execution of the second control command to the second remote server 20.

FIG. 10 illustrates operations of FIG. 9 in greater detail.

Referring to FIG. 10, the second remote server 20 may transmit the second control command for the second resource to the second server plug-in 220 according to the second protocol, in S1010. The second server plug-in 220 may receive the second control command for the second resource from the second remote server 20 according to the second protocol. In this case, the second resource may indicate the Bluetooth lock/unlock function, and the second control command may be the Bluetooth lock command.

The second server plug-in 220 may transmit the second control command to the control policy management module 240, in S1020.

The control policy management module 240 may send a request or inquiry for a control policy for the second resource to the control policy DB 250, in S1030. The control policy DB 250 may send or forward information about the control policy for the second resource to the control policy management module 240, in S1035.

Based on the control policy for the second resource being the master mode and the master server being the first remote server, the control policy management module 240 may transmit a request to approve the second control command to the first server plug-in 210, in S1040. The first server plug-in 210 may transmit the request to approve the second control command to the first remote server 10 according to the first protocol in S1045, and the first remote server 10 may transmit a response to the request to approve the second control command to the first server plug-in 210 according to the first protocol in S1050. The first server plug-in 210 may forward the response of the first remote server 10 to the control policy management module 240 in S1055. In this case, when the response is rejection, the control policy management module 240 may not execute the second control command for the second resource, and store an execution state (e.g., an execution failure) of the second control command in the control policy DB 250, in S1060.

The control policy management module 240 may transmit information indicating a failure of execution of the second control command to the second server plug-in 220 in S1070, and the second server plug-in 220 may transmit the execution failure information of the second control command to the second remote server 20 according to the second protocol in S1075.

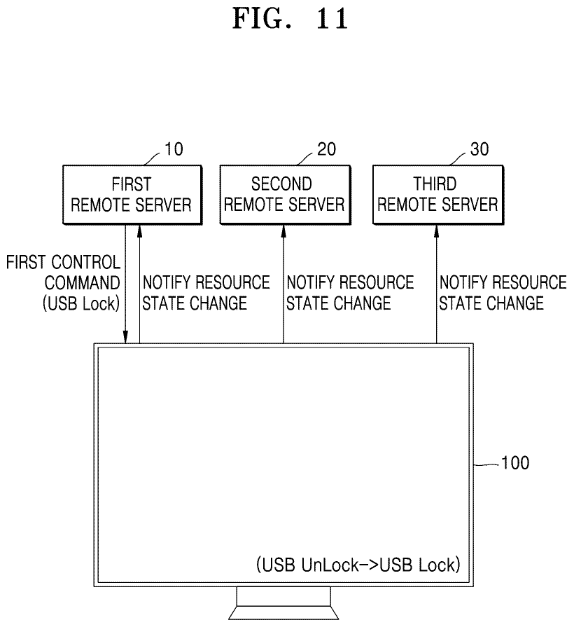

FIGS. 11, 12, 13, 14, 15, 16 and 17 include diagrams and signal flow diagrams illustrating example operations when a control policy for a resource is set to a security reinforcement mode, according to various embodiments.

In an embodiment, a control policy for the third resource may be set to the security reinforcement mode, and the first remote server, the second remote server and the third remote server may be configured to control the third resource.

In an embodiment, the security reinforcement mode is a mode that may execute a control command to enable a resource only when the control command to enable the resource is received from all the remote servers in a case that the resource is disabled by executing a control command to disable the resource, which is received from one or more of the first to third remote servers.

For example, the display device 100 is unable to execute the control command to enable the resource when there exist one or more control commands to disable the resource received from the first to third remote servers 10, 20 and 30.

Referring to FIG. 11, in an embodiment, the display device 100 may receive a first control command for the third resource from the first remote server 10. The first control command may include a control command to disable the third resource. For example, the first control command may be a command to lock the USB of the display device 100.

The display device 100 may execute the first control command for the third resource based on the control policy for the third resource being the security reinforcement mode and the first remote server 10 being able to control the third resource.

Based on a change in state of the third resource due to execution of the first control command for the third resource, the display device 100 may transmit state change information of the third resource to the first to third remote servers 10, 20 and 30.

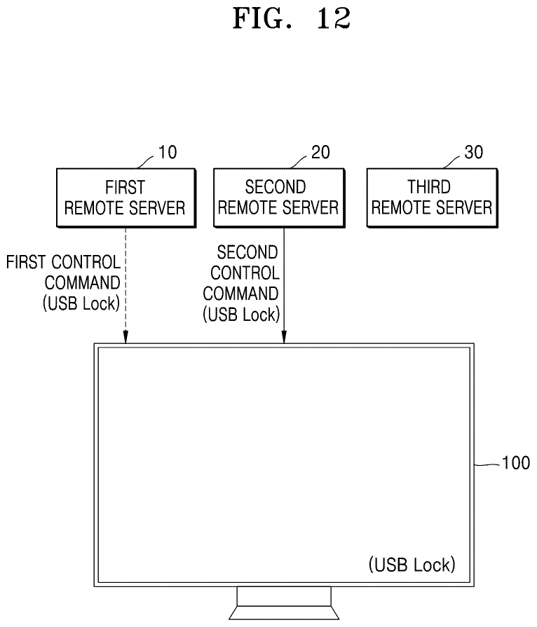

Referring to FIG. 12, the display device 100 may receive a second control command for the third resource from the second remote server 20 while the third resource is disabled. The second control command may include a control command to disable the third resource. For example, the second control command may be a command to lock the USB of the display device 100.

The display device 100 may execute the second control command. As the third resource has already been disabled due to execution of the first control command, the state of the third resource is not changed with the execution of the second control command (USB locked).

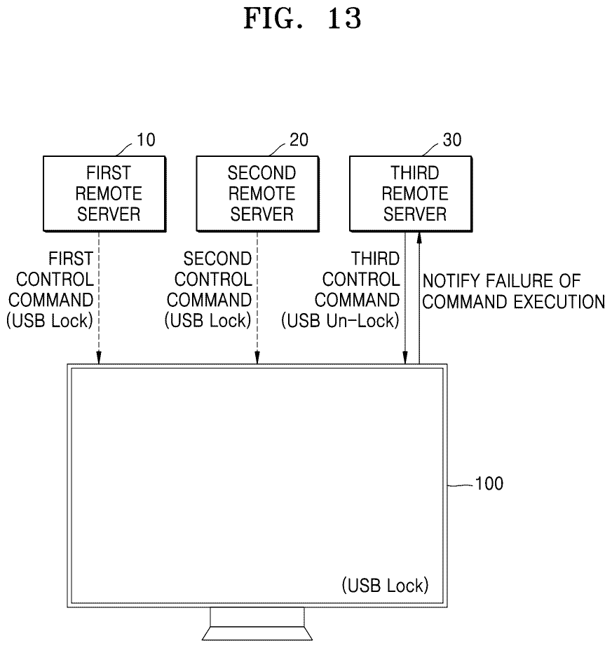

Referring to FIG. 13, the display device 100 may receive a third control command for the third resource from the third remote server 30 while the third resource is disabled. The third control command may include a control command to enable the third resource. For example, the third control command may be a command to unlock the USB of the display device 100.

The display device 100 does not execute the third control command because there exist one or more control commands (the first control command (USB lock command) and the second control command (USB lock command)) that disable the third resource.

The display device 100 may transmit information indicating a failure of execution of the third control command to the third remote server 30.

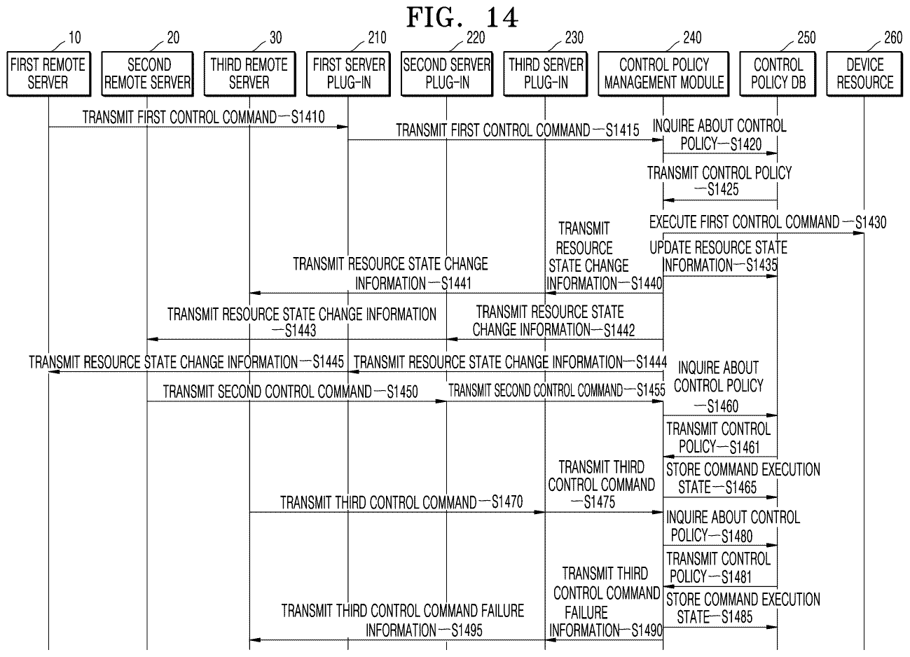

FIG. 14 illustrates operations of FIGS. 11,12 and 13 in greater detail.

Referring to FIG. 14, the first remote server 10 may transmit the first control command for the third resource to the first server plug-in 210 according to the first protocol, in S1410. The first server plug-in 210 may receive the first control command for the third resource from the first remote server 10 according to the first protocol.

The first server plug-in 210 may transmit the first control command for the third resource to the control policy management module 240, in S1415. In this case, the third resource may indicate a USB lock/unlock function, and the first control command may be a USB lock command.

The control policy management module 240 may send a request or inquiry for a control policy for the third resource to the control policy DB 250, in S1420. The control policy DB 250 may send or forward information about the control policy for the third resource to the control policy management module 240, in S1425.

The control policy management module 240 may execute the first control command based on the control mode for the third resource being the security reinforcement mode, in S1430. When the state of the third resource is changed as a result of executing the first control command for the third resource, the control policy management module 240 may update state information of the third resource stored in the control policy DB 250 by transmitting the state change information of the third resource to the control policy DB 250, in S1435. For example, when the USB is changed from the unlocked state into the locked state as a result of executing the first control command, the control policy management module 240 may update the state of the USB stored in the control policy DB 250 to locked from unlocked.

The control policy management module 240 may notify the change in state of the third resource to the first to third remote servers 10, 20 and 30. For example, the control policy management module 240 may transmit the state change information of the third resource (locked state of the USB) to the first server plug-in 210, the second server plug-in 220 and the third server plug-in 230, in S1440, S1442 and S1444. The first server plug-in 210 may transmit the state change information of the third resource to the first remote server 10 according to the first protocol, in S1445. The second server plug-in 220 may transmit the state change information of the third resource to the second remote server 20 according to the second protocol, in S1443. The third server plug-in 230 may transmit the state change information of the third resource to the third remote server 30 according to the third protocol, in S1441.

Afterwards, the second remote server 20 may transmit the second control command for the third resource to the second server plug-in 220 according to the second protocol, in S1450. The second server plug-in 220 may receive the second control command for the third resource from the second remote server 20 according to the second protocol.

The second server plug-in 220 may transmit the second control command for the third resource to the control policy management module 240, in S1455. In this case, the second control command may be the USB lock command.

The control policy management module 240 may send a request or inquiry for a control policy for the third resource to the control policy DB 250, in S1460. The control policy DB 250 may send or forward information about the control policy for the third resource to the control policy management module 240, in S1461.

The control policy management module 240 may execute the second control command based on the control mode for the third resource being the security reinforcement mode. When there is no change in state of the third resource as a result of executing the second control command for the third resource, the state change information of the resource may not be transmitted to the first to third remote servers 10, 20 and 30.

The control policy management module 240 may store a state of execution (e.g., execution success) of the second control command in the control policy DB 250, in S1465.

Afterwards, the third remote server 30 may transmit the third control command for the third resource to the third server plug-in 230 according to the third protocol, in S1470. The third server plug-in 230 may receive the third control command for the third resource from the third remote server 30 according to the third protocol.

The third server plug-in 230 may transmit the third control command for the third resource to the control policy management module 20, in S1475. In this case, the third control command may be the USB unlock command.

The control policy management module 240 may send a request or inquiry for a control policy for the third resource to the control policy DB 250, in S1480. The control policy DB 250 may send or forward information about the control policy for the third resource to the control policy management module 240, in S1481.

Based on the control mode for the third resource being the security reinforcement mode and the first control command received from the first remote server and the second control command received from the second remote server being the USB lock command, the control policy management module 240 does not execute the third control command. The control policy management module 240 may store a state of execution (e.g., execution failure) of the third control command in the control policy DB 250, in S1485.

Furthermore, the control policy management module 240 may transmit information indicating a failure of execution of the third control command to the third server plug-in 230 in S1490, and the third server plug-in 230 may transmit the execution failure information of the third control command to the third remote server 30 according to the third protocol in S1495.

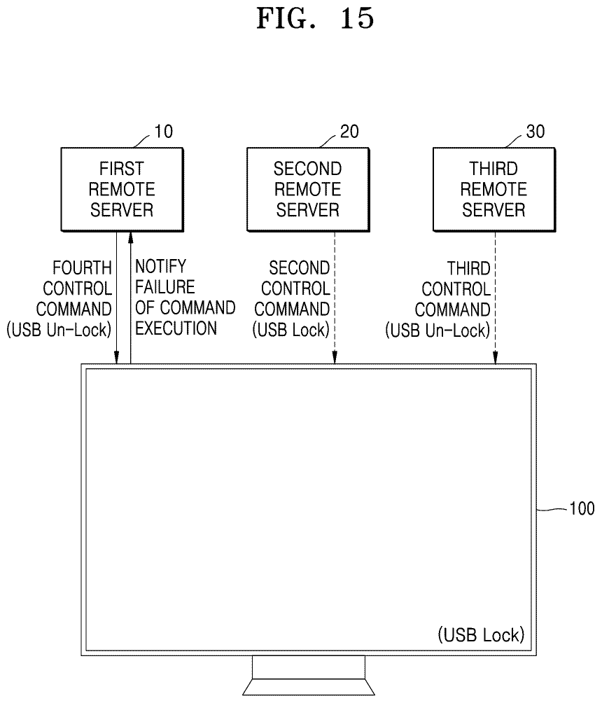

Referring to FIG. 15, in an embodiment, the display device 100 may receive a fourth control command for the third resource from the first remote server 10 while the third resource is disabled (e.g., the USB is locked). The fourth control command may include a control command to enable the third resource. For example, the fourth control command may be a command to unlock the USB of the display device 100.

The display device 100 does not execute the fourth control command because there exist one or more control commands (the second control command) that disable the third resource.

The display device 100 may transmit information indicating a failure of execution of the fourth control command to the first remote server 10.

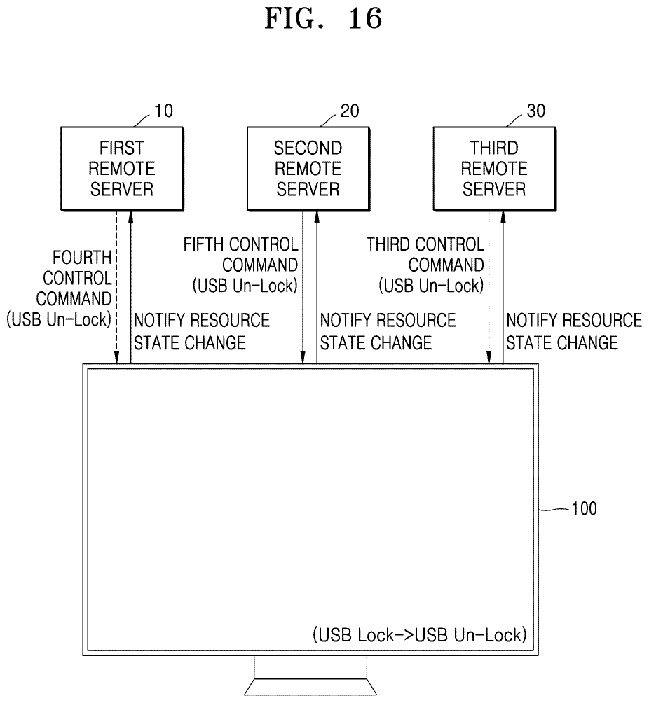

Referring to FIG. 16, the display device 100 may receive a fifth control command for the third resource from the second remote server 20 while the third resource is disabled. The fifth control command may include a control command to enable the third resource. For example, the fifth control command may be a command to unlock the USB of the display device 100.

The display device 100 may execute the fifth control command because there are no control commands to disable the third resource but exist only control commands to enable the third resource (the third control command (USB unlock command) and the fourth control command (USB unlock command)). As a result of executing the fifth control command, the third resource may be changed into the enabled state (USB unlocked state) from the disabled state (USB locked state).

Based on a change in state of the third resource due to the execution of the fifth control command for the third resource, the display device 100 may transmit state change information of the third resource to the first to third remote servers 10, 20 and 30.

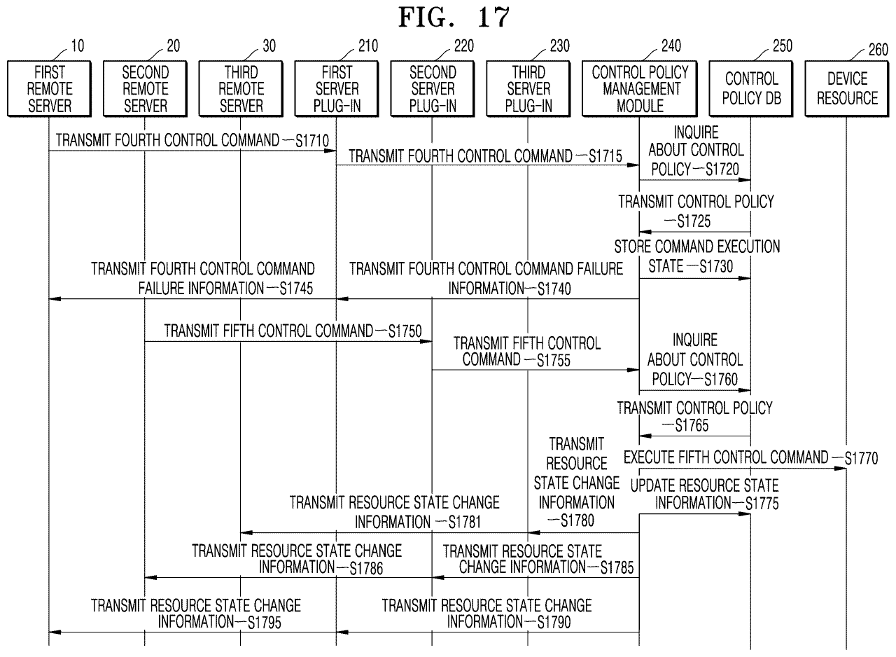

FIG. 17 illustrates operations of FIGS. 15 and 16 in greater detail.

Referring to FIG. 17, the first remote server 10 may transmit the fourth control command for the third resource to the first server plug-in 210 according to the first protocol, in S1710. The first server plug-in 210 may receive the fourth control command for the third resource from the first remote server 10 according to the first protocol.

The first server plug-in 210 may transmit the fourth control command for the third resource to the control policy management module 240, in S1715. In this case, the fourth control command may be the USB unlock command.

The control policy management module 240 may send a request or inquiry for a control policy for the third resource to the control policy DB 250, in S1720. The control policy DB 250 may send or forward information about the control policy for the third resource to the control policy management module 240, in S1725.

Based on the control mode for the third resource being the security reinforcement mode, the second control command received from the second remote server 20 being the USB lock command and the third control command received from the third remote server 30 being the USB unlock command, the control policy management module 240 does not execute the fourth control command. The control policy management module 240 may store a state of execution (e.g., execution failure) of the fourth control command in the control policy DB 250, in S1730.

The control policy management module 240 may transmit information indicating a failure of execution of the fourth control command to the first server plug-in 210 in S1740, and the first server plug-in 210 may transmit the execution failure information of the fourth control command to the first remote server 10 according to the first protocol in S1745.

The second remote server 20 may transmit the fifth control command for the third resource to the second server plug-in 220 according to the second protocol, in S1750. The second server plug-in 220 may receive the fifth control command for the third resource from the second remote server 20 according to the second protocol.

The second server plug-in 220 may transmit the fifth control command for the third resource to the control policy management module 240, in S1755. In this case, the fifth control command may be the USB unlock command.

The control policy management module 240 may send a request or inquiry for a control policy for the third resource to the control policy DB 250, in S1760. The control policy DB 250 may send or forward information about the control policy for the third resource to the control policy management module 240, in S1765.

Based on the control mode for the third resource being the security reinforcement mode and the fourth control command received from the first remote server 10 and the third control command received from the third remote server 30 being the USB unlock command, the control policy management module 240 may execute the fifth control command in S1770.

When the state of the third resource is changed as a result of executing the fifth control command for the third resource, the state change information of the third resource may be transmitted to the control policy DB 250, thereby updating state information of the third resource stored in the control policy DB 250, in S1775. For example, when the USB is changed from the unlocked state into the locked state as a result of executing the first control command, the control policy management module 240 may update the state of the USB stored in the control policy DB 250 to locked from unlocked.

The control policy management module 240 may notify the change in state of the third resource to the first to third remote servers 10, 20 and 30. For example, the control policy management module 240 may transmit the state change information of the third resource (locked state of the USB) to the first server plug-in 210, the second server plug-in 220 and the third server plug-in 230, in S1780, S1785 and S1790. The first server plug-in 210 may transmit the state change information of the third resource to the first remote server 10 according to the first protocol, in S1781. The second server plug-in 220 may transmit the state change information of the third resource to the second remote server 20 according to the second protocol, S1786. The third server plug-in 230 may transmit the state change information of the third resource to the third remote server 30 according to the third protocol, in S1795.

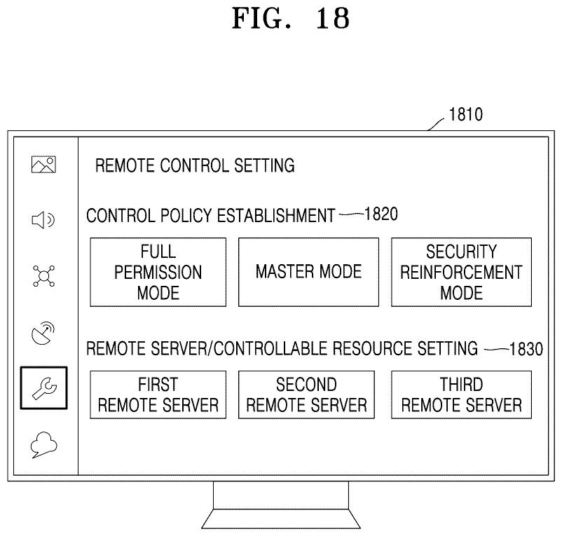

FIG. 18 is a diagram illustrating an example user interface screen for establishing a resource control policy, according to various embodiments.

Referring to FIG. 18, in an embodiment, the display device 100 may display a remote control setting screen 1810 for setting remote control to control a resource of the display device 100 based on an input (e.g., a user input).

In an embodiment, the remote control setting screen 1810 may include a menu 1820 to establish a control policy that becomes a basis for controlling a resource of the display device 100. For example, the display device 100 may establish a control policy for each resource based on a user input. The display device 100 may set a resource of the display device 100 into one of the full permission mode, the master mode and the security reinforcement mode based on a user input. It is not, however, limited thereto.

When the control policy (control mode) for a resource is set to the master mode, the display device 100 may designate one of a plurality of remote servers as a master server based on a user input.

The remote control setting screen 1810 may also include a menu 1830 for setting resources controllable by each remote server. For example, the display device 100 may select one of the plurality remote servers based on a user input, and set a resource controllable by the selected remote server. It is not, however, limited thereto.

The remote control setting screen is not, however, limited to the aforementioned examples, and may further include a menu for setting various conditions or functions related to remotely controlling a resource of the display device 100.

Although the remote control setting screen is shown as being displayed on the display device 100 in FIG. 18, it is not limited thereto, and the remote control setting screen may be displayed on a plurality of remote servers. The display device 100 may also set various conditions or functions related to remotely controlling a resource of the display device 100 based on a user input input to a remote server.

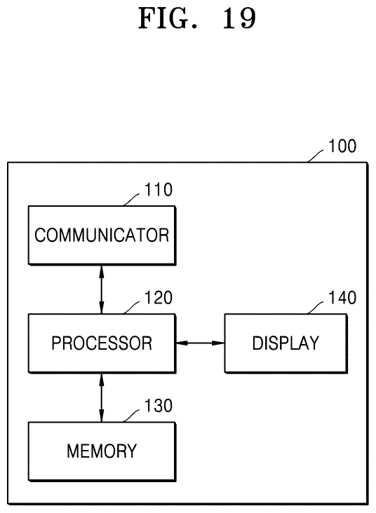

FIG. 19 is a block diagram illustrating an example configuration of a display device, according to various embodiments.

Referring to FIG. 19, the display device 100 may include a communicator (e.g., including communication circuitry) 110, a processor (e.g., including processing circuitry) 120, a memory 130 and a display 140.

In an embodiment, the communicator 110 may include various communication circuitry and transmit and/or receive data or a signal to or from an external device (e.g., the plurality of remote servers 10, 20 and 30). For example, the communicator 110 may receive a control command to control a resource of the display device 100 from the plurality of remote servers 10, 20 and 30.

In an embodiment, the communicator 110 may include a wireless fidelity (Wi-Fi) module, a Bluetooth module, an infrared communication module, a wireless communication module, a local area network (LAN) module, an Ethernet module, etc. In this case, each communication module may be implemented in the form of at least one hardware chip.

The Wi-Fi module and the Bluetooth module of the communicator 110 perform communication in a Wi-Fi scheme and a bluetooth scheme, respectively. In the case of using the Wi-Fi module or the Bluetooth module, it may first transmit or receive various connection information such as a service set identifier (SSID) and a session key, use this to establish communication, and then transmit and receive various information. The wireless communication module may include at least one communication chip for performing communication according to various wireless communication standards such as zigbee, third generation (3G), third generation partnership project (3GPP), long term evolution (LTE), LTE advanced (LTE-A), fourth generation (4G), fifth generation (5G), etc.

In an embodiment, the communicator 110 may include a server plug-in corresponding to each of the remote servers 10, 20 and 30. For example, the communicator 110 may include the first server plug-in 210, the second server plug-in 220 and the third server plug-in 230 which are shown and described in FIGS. 2 to 18. The communicator 110 may use a server plug-in corresponding to each of the remote servers 10, 20 and 30 to transmit or receive a control command, data, etc., through a protocol agreed with each of the remote servers 10, 20 and 30.

In an embodiment, the communicator 110 may receive, from a control device, a control signal or control command corresponding to a user input (e.g., an input to a key or button of the control device). For example, the communicator 110 may receive a control signal or control command to power on the display device 100 from the control device. The communicator 110 may also receive a control signal or control command corresponding to a user input for the remote control setting menu from the control device.

In an embodiment, the processor 120 may include various processing circuitry and controls general operation of the display device 100 and signal flows between internal components of the display device 100, and processes data.

The processor 120 may include a single core, dual cores, triple cores, quad cores, and their multiple cores. The processor 120 may also include a plurality of processors. For example, the processor 120 may be implemented with a main processor (not shown) and a sub processor (not shown).

Furthermore, the processor 120 may include at least one of a central processing unit (CPU), a graphic processing unit (GPU) or a video processing unit (VPU). Alternatively, it may be implemented in the form of a system on chip (SoC) that integrates at least one of the CPU, the GPU or the VPU. The processor 120 may further include a neural processing unit (NPU). Thus, the processor 120 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

In an embodiment of the disclosure, the memory 130 may store various data, programs, or applications for driving and controlling the display apparatus 100.

In an embodiment, the memory 130 may include the control policy DB 250 shown and described in FIGS. 2 to 18.

The program stored in the memory 130 may include one or more instructions. The program (one or more instructions) or the application stored in the memory 130 may be executed by the processor 120.

In an embodiment, the processor 120 may execute the one or more instructions stored in the memory 130 to perform operations performed by the control policy management module 240 shown and described in FIGS. 2 to 18.

For example, the processor 120 may execute the one or more instructions stored in the memory 130 to determine whether to execute a control command received from at least one of the plurality of remote servers based on a control policy for a resource of the display device 100.

In an embodiment, the control policy for the resource may include information about a control mode set for each resource, information about a master server when the control mode is a master mode, information about a range of resources controllable by each remote server, information about a security reinforcement mode, etc.

For example, when the control mode for the first resource is the full permission mode, all the remote servers are able to control the first resource. The processor 120 may execute one or more instructions stored in the memory 130 to determine to execute a control command for the first resource received from the remote servers.

When the control mode for the second resource is the master mode, the processor 120 may execute the one or more instructions stored in the memory 130 to inquire a remote server designated as a master server about whether to execute a control command for a second resource received from a remote server other than the master server. The processor 120 may determine whether to execute the control command according to a response from the master server.

In a case that the control mode for the third resource is the security reinforcement mode, the processor 120 may execute the one or more instructions stored in the memory 130 to determine to execute a control command for the third resource received from a remote server when the control command is a command to disable the third resource. On the other hand, when the control command for the third resource is a command to enable the third resource, the processor 120 may determine whether to perform execution according to control commands received from the other remote servers. For example, when all the control commands received from the other remote servers are also the command to enable the third resource, the control command may be determined to be executed.

The processor 120 may execute the one or more instructions stored in the memory 130 to execute the control command when determining to execute the control command.

The processor 120 may execute the one or more instructions stored in the memory 130 to transmit state change information of the resource to the plurality of remote servers 10, 20 and 30 when a state of the resource is changed.

The processor 120 may execute the one or more instructions stored in the memory 130 to store a state of execution of the control command and a state of the resource in the control policy DB 250.

In an embodiment, the display 140 generates a driving signal by converting an image signal, a data signal, an on-screen display (OSD) signal, a control signal, etc., processed by the processor 120. The display 140 may be implemented by a PDP, an LCD, OLEDs, a flexible display, a three dimensional (3D) display, or the like. Furthermore, the display 140 may have a touchscreen to be used for an input device as well as for an output device.

In an embodiment, the display 140 may display a remote control setting screen for setting remote control to control a resource of the display device 100. It is not, however, limited thereto.

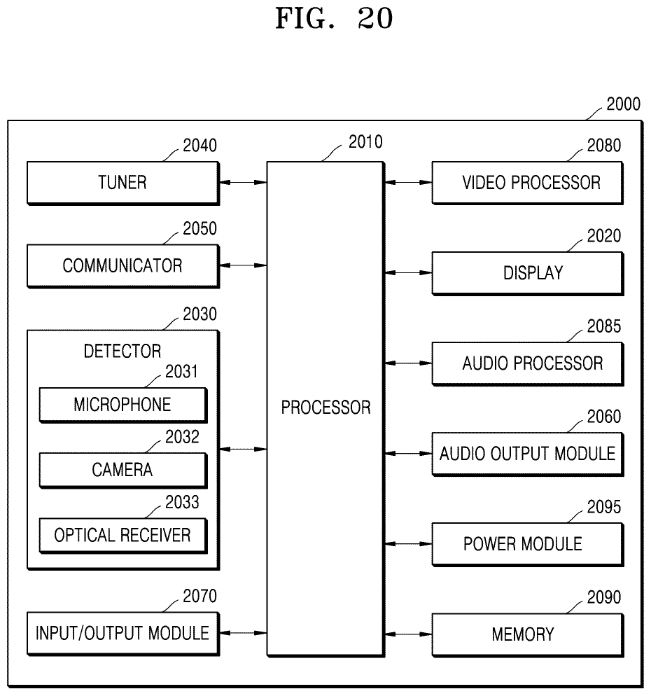

FIG. 20 is a block diagram illustrating an example configuration of a display device, according to various embodiments.

A display device 2000 of FIG. 20 may be an example of the display device 100 as described above in connection with FIGS. 1 and 19.

Referring to FIG. 20, in an embodiment, the display device 2000 may include a tuner 2040, a processor (e.g., including processing circuitry) 2010, a display 2020, a communicator (e.g., including communication circuitry) 2050, a detector (e.g., including various circuitry) 2030, an input/output module (e.g., including input/output circuitry) 2070, a video processor (e.g., including video processing circuitry) 2080, an audio processor (e.g., including audio processing circuitry) 2085, an audio output module (e.g., including audio output circuitry) 2060, a memory 2090, and a power module (e.g., including a power supply) 2095.

The communicator 2050 of FIG. 20 may correspond to the communicator 110 of FIG. 19, the processor 2010 of FIG. 20 to the processor 120 of FIG. 19, the memory 2090 of FIG. 20 to the memory 130 of FIG. 19, and the display 2020 of FIG. 20 to the display 140 of FIG. 19. Accordingly, what are described above may not be repeated here.

In an embodiment of the disclosure, the tuner 2040 may tune in to and select a frequency of a channel that the display apparatus 2000 intends to receive from among a lot of radio components through amplification, mixing, resonance of broadcast signals received wiredly or wirelessly. The broadcast signal includes audio, video, and additional information, e.g., electronic program guide (EPG).

The tuner 2040 may receive broadcast signals from various sources such as terrestrial broadcasters, cable broadcasters, satellite broadcasters, Internet broadcasters, etc. The tuner 2040 may also receive broadcast signals from a source such as an analog broadcaster or a digital broadcaster.

In an embodiment, the communicator 2050 may receive a control signal or a control command from an external control device. For example, the communicator 2050 may include an IR module capable of transmitting or receiving signals to or from an external control device according to an IR communication standard. Specifically, the communicator 2050 may receive, from a control device, a control signal or control command corresponding to a user input (e.g., an input to a key or button of the control device).

In an embodiment of the disclosure, the detector 2030 may include various circuitry and detect the user's voice, the user's image or the user's interaction, and may include a microphone 2031, a camera 2032, and an optical receiver 2033.

The microphone 2031 receives a voice uttered by the user. The microphone 2031 may convert the received voice into an electrical signal and output the electrical signal to the processor 2010. The user's voice may include, for example, a voice corresponding to a menu or function of the display device 2000. For example, the microphone 2031 may receive a user's voice corresponding to a command to turn the display, and convert the received voice into an electric signal and output the electric signal to the processor 2010.

The camera 2032 may receive an image, e.g., successive frames, corresponding to a motion of the user including a gesture in a camera recognition range. The processor 2010 may select a menu displayed on the display device 2000 based on a received motion recognition result or perform control corresponding to the motion recognition result. For example, the processor 2010 may receive the image from the camera 2032, recognize the user's motion corresponding to the turning of the display from the received image, and accordingly, turn the display.

The optical receiver 2033 may include various circuitry and receives an optical signal (including a control signal) received from an external control device through a light window (not shown) on the bezel of the display 2020. The optical receiver 2033 may receive an optical signal corresponding to the user input, e.g., touch, push, touching gesture, voice, or motion of the user, from the remote control device. A control signal may be extracted from the received optical signal under the control of the processor 2010.

In an embodiment of the disclosure, the input/output module 2070 may include various input/output circuitry and receive a video (e.g., a moving image), an audio (e.g., a speech, music, etc.), additional information (e.g., an EPG), or the like from outside of the display apparatus 2000. The input/output module 2070 may include any of a high-definition multimedia interface (HDMI), a mobile high-definition link (MHL), a universal serial bus (USB), a display port (DP), a thunderbolt, a video graphics array (VGA) port, an RGB port, a D-subminiature (D-SUB), a digital visual interface (DVI), a component jack, and a PC port.

The processor 2010 may include various processing circuitry (see, e.g., description above of processor 120 in FIG. 19) and controls general operation of the display device 2000 and signal flows between the internal components of the display device 2000, and performs a function of processing data. The processor 2010 may run an operating system (OS) and various applications stored in the memory 2090 at the user's request or when a preset (e.g., specified) and stored condition is met.

The processor 2010 may include a RAM to store a signal or data received from outside of the display device 2000 or to be used for a storage sector corresponding to various tasks performed in the display device 2000, a ROM to store a control program to control the display device 2000 and a processor.

The video processor 2080 may include various video processing circuitry and/or executable program instructions and processes video data received by the display device 2000. The video processor 2080 may perform various image processes such as decoding, scaling, noise filtering, frame rate conversion, resolution conversion, etc., on the video data.

The audio processor 2085 may include various audio processing circuitry and/or executable program instructions and processes audio data. The audio processor 2085 may perform various processes such as decoding, amplification, noise filtering, etc., on the audio data. The audio processor 2085 may include a plurality of audio processing modules to process audio corresponding to a plurality of contents.

The audio output module 2060 may include various audio output circuitry and outputs audio included in a broadcast signal received through the tuner 2040 under the control of the processor 2010. The audio output module 2060 may output audio, e.g., voice or sound, received through the communication module 2050 or the input/output module 2070. Furthermore, the audio output module 2060 may output audio stored in the memory 2090 under the control of the processor 2010. The audio output module 2060 may include at least one of a speaker, a headphone output terminal or a Sony/Phillips digital interface (S/PDIF) output terminal.

The power module 2095 may include a power supply that supplies power received from an external power source to the components in the display device 2000 under the control of the processor 2010. Furthermore, the power module 2095 may supply power output from one or two or more batteries (not shown) located in the display device 2000 to the internal components under the control of the processor 2010.

The memory 2090 may store various data, programs, or applications for driving and controlling the display device 2000 under the control of the processor 2010. Although not shown, the memory 2090 may include a broadcast reception module, a channel control module, a volume control module, a communication control module, a speech recognition module, a motion recognition module, a photo reception module, a display control module, an audio control module, an external input control module, a power control module, a power control module of a wirelessly connected external device, a speech database (DB), or a motion DB. The modules and DBs (not shown) of the memory 2090 may be implemented in software to perform, in the display device 2000, a broadcast reception control function, a channel control function, a volume control function, a communication control function, a speech recognition function, a motion recognition function, photo reception control function, a display control function, an audio control function, an external input control function, a power control function or a power control function of the wirelessly (e.g., Bluetooth) connected external device. The processor 2010 may use the software stored in the memory 2090 to perform each of the functions.

The block diagrams of the display device 100 or 2000 as shown in FIGS. 19 and 20 are merely examples. Components of the block diagrams may be merged, added or omitted according to actual specifications of the display device 100 or 2000. In other words, two or more components may be merged into one, or a single component may be split into two or more components as needed. Functions performed in the blocks are shown for explaining the various embodiments of the disclosure, and the disclosure is not limited to the detailed operation or components corresponding to the blocks.

According to an embodiment, a display device may include a communicator performing communication with one or more remote servers, a memory storing one or more instructions, and at least one processor including a processing circuit.

In an embodiment, when the one or more instructions are individually or collectively executed by the at least one processor, the display device may receive a control command for at least one resource of the display device from the one or more remote servers.

In an embodiment, when the one or more instructions are individually or collectively executed by the at least one processor, the display device may execute the control command based on a control policy for the resource.

In an embodiment, when the one or more instructions are individually or collectively executed by the at least one processor, the display device may transmit state information of the resource to the remote servers based on a change in state of the resource as a result of executing the control command.

In an embodiment, a control policy for a resource may include at least one of a control type of the at least one resource, a control mode for the at least one resource, information about a remote server capable of controlling the at least one resource, information about a master server, information about a security reinforcement mode, or information about a range of resources controllable by each remote server.

In an embodiment, the resource may indicate at least one function provided by the display device.

In an embodiment, the resource may include at least one of a USB lock/unlock function, a Wi-Fi lock/unlock function, a Bluetooth function, volume mute or a rebooting function.

In an embodiment, the display device may include a server plug-in corresponding to each of the remote servers.

When the one or more instructions are individually or collectively executed by the at least one processor, the display device may receive control commands from the remote servers through the server plug-in.

When the one or more instructions are individually or collectively executed by the at least one processor, the display device may receive a first control command for a first resource from the one or more remote servers.

When the one or more instructions are individually or collectively executed by the at least one processor, the display device may execute the first control command based on a control mode for the first resource being a full permission mode.

When the one or more instructions are individually or collectively executed by the at least one processor, the display device may transmit state information of the resource to the remote servers, based on a change in state of the first resource as a result of executing the first control command.

When the one or more instructions are individually or collectively executed by the at least one processor, the display device may receive a second control command for a second resource from a second server among the one or more remote servers.

When the one or more instructions are individually or collectively executed by the at least one processor, the display device may transmit a request to approve execution of the second control command to a third server designated as a master server among the one or more remote servers, based on a control mode for the second resource being a master designation mode.

When the one or more instructions are individually or collectively executed by the at least one processor, the display device may receive a response to the request for approval from the third server.

When the one or more instructions are individually or collectively executed by the at least one processor, the display device may execute the second control command based on the response.

When the one or more instructions are individually or collectively executed by the at least one processor, the display device may transmit state information of the resource to the remote servers based on a change in state of the second resource as a result of executing the second control command.

When the one or more instructions are individually or collectively executed by the at least one processor, the display device may transmit information about a failure of execution of the second control command to the second server without executing the second control command, based on a response of rejecting the execution of the second control command being received from the third server.

When the one or more instructions are individually or collectively executed by the at least one processor, the display device may receive a third control command for a third resource from a fourth server among the one or more remote servers.

When the one or more instructions are individually or collectively executed by the at least one processor, the display device may execute the third control command, based on the control mode for the third resource being a security reinforcement mode and the third control command being a control command to disable the third resource.

When the one or more instructions are individually or collectively executed by the at least one processor, the display device may transmit state information of the resource to the remote servers, based on a change in state of the third resource as a result of executing the third control command.

When the one or more instructions are individually or collectively executed by the at least one processor, the display device may receive a fourth control command for the third resource from a fifth server among the one or more remote servers.

When the one or more instructions are individually or collectively executed by the at least one processor, the display device may transmit information about a failure of execution of the fourth control command to the fifth server without executing the fourth control command, based on the fourth control command being a control command to enable the third resource and at least one of control commands corresponding to the remote servers being a control command to disable the third resource.

When the one or more instructions are individually or collectively executed by the at least one processor, the display device may receive a fifth control command for the third resource from a sixth server among the one or more remote servers.

When the one or more instructions are individually or collectively executed by the at least one processor, the display device may execute the fifth control command, based on the fifth control command being a control command to enable the third resource and all control commands corresponding to the remote servers being a control command to enable the third resource.

When the one or more instructions are individually or collectively executed by the at least one processor, the display device may transmit state information of the resource to the remote servers, based on a change in state of the third resource as a result of executing the fifth control command.

The display device may further include a user interface for receiving a user input to establish a control policy for the at least one resource.

The display device may further include a database for storing at least one of a control policy set for the at least one resource, whether to execute control commands received from the remote servers, and state information of the resource.

According to an embodiment, an operating method of a display device may include receiving a control command for at least one resource of the display device from one or more remote servers.

In an embodiment, the operating method of the display device may include executing the control command based on a control policy for the resource.

In an embodiment, the operating method of the display device may include transmitting state information of the resource to the remote servers, based on a change in state of the resource as a result of executing the control command.

The receiving of the control command may include receiving a first control command for a first resource from a first server among the one or more remote servers.

The executing of the control command may include executing the first control command based on a control mode for the first resource being a full permission mode.

The transmitting of the state information of the resource to the remote servers may include transmitting the state information of the resource to the remote servers based on a change in state of the first resource as a result of executing the first control command.

The receiving of the control command may include receiving a second control command for a second resource from a second server among the one or more remote servers.

The executing of the control command may include transmitting a request to approve execution of the second control command to a third server designated as a master server among the one or more remotes servers, based on the control mode for the second resource being a master designation mode.

The executing of the control command may include receiving a response to the request for approval from the third server.

The executing of the control command may include executing the second control command based on the response.

The transmitting of the state information of the resource to the remote servers may include transmitting the state information of the resource to the remote servers, based on a change in state of the second resource as a result of executing the second control command.

In an embodiment, the operating method of the display device may further include transmitting information about a failure of execution of the second control command to the second server without executing the second control command, based on a response of rejecting the execution of the second control command being received from the third server.

The receiving of the control command may include receiving a third control command for a third resource from a fourth server among the one or more remote servers.

The executing of the control command may include executing the third control command, based on a control mode for the third resource being a security reinforcement mode and the third control command being a control command to disable the third resource.

The transmitting of the state information of the resource to the remote servers may include transmitting the state information of the resource to the remote servers, based on a change in state of the third resource as a result of executing the third control command.

In an embodiment, the operating method of the display device may further include receiving a fourth control command for the third resource from a fifth server among the one or more remote servers.

In an embodiment, the operating method of the display device may further include transmitting information about a failure of execution of the fourth control command to the fifth server without executing the fourth control command, based on the fourth control command being a control command to enable the third resource and at least one of control commands corresponding to the remote servers being a control command to disable the third resource.

In an embodiment, the operating method of the display device may further include receiving a fifth control command for the third resource from a sixth server among the one or more remote servers.

In an embodiment, the operating method of the display device may further include executing the fifth control command, based on the fifth control command being a control command to enable the third resource and control commands corresponding to the remote servers being control commands to enable the third resource.

In an embodiment, the operating method of the display device may further include transmitting state information of the resource to the remote servers, based on a change in state of the third resource as a result of executing the fifth control command.

In an embodiment, the display device may mediate between control commands received from a plurality of remote servers by processing the control commands according to a control policy for the resource.

In an embodiment, the display device may notify a state change of a resource to remote servers so that the state of the resource of the display device may be shown consistently in the remote servers.

In an embodiment, the display device may set a different control policy for each resource and control the resources differently according to their characteristics.

In an embodiment, the display device may set a master mode or a security reinforcement mode to reinforce security for control over resources of the display device.

In an embodiment, the operating method of the display device may be implemented in program instructions which may be executable by various computing means and recorded on computer-readable media. The computer-readable media may include program instructions, data files, data structures, etc., separately or in combination. The program instructions recorded on the media may be designed and configured specially for the disclosure, or may be well-known to those of ordinary skill in the art of computer software. Examples of the computer readable recording medium include a magnetic medium such as a hard disk, a floppy disk and a magnetic tape, an optical medium such as a compact disc read-only memory (CD-ROM) and a digital versatile disc (DVD), a magneto-optical medium such as a floptical disk, and a hardware device specially configured to store and perform program instructions, such as a read-only memory (ROM), a random-access memory (RAM), a flash memory, etc. Examples of the program instructions include not only machine language codes but also high-level language codes which are executable by various computing means using an interpreter.

The operating method of the display device according to the example embodiments of the disclosure may be included and provided in a computer program product. The computer program product may be a commercial product that may be traded between a seller and a buyer.

The computer program product may include a software program and a computer-readable storage medium having the software program stored thereon. For example, the computer program product may include a product in the form of a software program that is electronically distributed by the manufacturer of the electronic device or by an electronic market (e.g., Google Play Store®, or App Store®). For the electronic distribution, at least a portion of the software program may be stored in a storage medium or arbitrarily created. In this case, the storage medium may be one of a server of the manufacturer or of a relay server that temporarily stores the software program.

In a system including a server and a client device, the computer program product may include a storage medium of the server or a storage medium of the client device. Alternatively, when there is a third device (e.g., a smart phone) communicatively connected to the server or the client device, the computer program product may include a storage medium of the third device. In another example, the computer program product may be transferred from the server to the client device or the third device, or may include a software program itself that is transferred from the third device to the client device.

In this case, one of the server, the client device, and the third device may execute the computer program product to perform the method according to the example embodiments of the disclosure. Alternatively, two or more of the server, the client device, and the third device may execute the computer program product to perform the method according to the example embodiments of the disclosure in a distributed fashion.

For example, the server (e.g., a cloud server or an AI server) may execute the computer program product stored therein to control the client device communicatively connected to the server to perform the method according to the example embodiments of the disclosure.

Various example embodiments of the disclosure have been illustrated and described, but it will be understood that various modifications can be made without departing the scope of the disclosure. Thus, it will be apparent to those ordinary skilled in the art that the disclosure is not limited to the various example embodiments described, and includes the appended claims and their equivalents. It will also be understood that any of the embodiment(s) described herein may be used in conjunction with any other embodiment(s) described herein.

What is claimed is:

1. A display device comprising:
a communicator comprising communication circuitry configured to communicate with one or more remote servers;
a memory storing one or more instructions; and
at least one processor comprising processing circuitry,
wherein at least one processor, individually and/or collectively, is configured to execute the one or more instructions and to cause the display device to:
receive a control command for at least one resource of the display device from the one or more remote servers;
execute the control command, based on a control policy for the resource; and
transmit state information of the resource to the remote servers, based on a change in state of the resource as a result of executing the control command.

2. The display device of claim 1, wherein the control policy for the resource comprises: at least one of a control type of the at least one resource, a control mode for the at least one resource, information about a remote server capable of controlling the at least one resource, information about a master server, information about a security reinforcement mode, and/or information about a range of resources controllable by each remote server.

3. The display device of claim 1, wherein:
the resource indicates at least one function provided by the display device, and
the resource comprises at least one of a USB lock/unlock function, a Wi-Fi lock/unlock function, a Bluetooth function, a volume mute function or a rebooting function.

4. The display device of claim 1, further comprising:
a server plug-in corresponding to each of the remote servers,
wherein at least one processor, individually and/or collectively, is configured to cause the display device to receive a control command from the remote servers through the server plug-in.

5. The display device of claim 1, wherein at least one processor, individually and/or collectively, is configured to cause the display device to:
receive a first control command for a first resource from a first server among the one or more remote servers;
execute the first control command, based on a control mode for the first resource being a full permission mode; and
transmit state information of the resource to the remote servers, based on a change in state of the first resource as a result of executing the first control command.

6. The display device of claim 1, wherein at least one processor, individually and/or collectively is configured to cause the display device to:
receive a second control command for a second resource from a second server among the one or more remote servers;
transmit a request to approve execution of the second control command to a third server designated as a master server among the one or more remote servers, based on a control mode for the second resource being a master designation mode;
receive a response to the request for approval from the third server;
execute the second control command, based on the response; and
transmit state information of the resource to the remote servers, based on a change in state of the second resource as a result of executing the second control command.

7. The display device of claim 6, wherein at least one processor, individually and/or collectively is configured to cause the display device to:
not execute the second control command, based on a response of rejecting execution of the second control command being received from the third server; and
transmit information about a failure of execution of the second control command to the second server.

8. The display device of claim 1, wherein at least one processor, individually and/or collectively, is configured to cause the display device to:
receive a third control command for a third resource from a fourth server among the one or more remote servers;
execute the third control command, based on a control mode for the third resource being a security reinforcement mode and on the third control command being a control command to disable the third resource; and
transmit state information of the resource to the remote servers, based on a change in state of the third resource as a result of executing the third control command.

9. The display device of claim 8, wherein at least one processor, individually and/or collectively, is configured to cause the display device to:
receive a fourth control command for the third resource from a fifth server among the one or more remote servers;
not execute the fourth control command, based on the fourth control command being a control command to enable the third resource and on at least one of control commands corresponding to the remote servers being a control command to disable the third resource; and
transmit information about a failure of execution of the fourth control command to the fifth server.

10. The display device of claim 8, wherein at least one processor, individually and/or collectively, is configured to cause the display device to:
receive a fifth control command for the third resource from a sixth server among the one or more remote servers;
execute the fifth control command, based on the fifth control command being a control command to enable the third resource and on all control commands corresponding to the remote servers being control commands to enable the third resource; and
transmit state information of the resource to the remote servers, based on a change in state of the third resource as a result of executing the fifth control command.

11. The display device of claim 1, further comprising:
a user interface configured to receive an input to set a control policy for the at least one resource.

12. The display device of claim 1, further comprising:
a database storing at least one of a control policy set for the at least one resource, including whether to execute control commands received from the remote servers, and state information of the resource.

13. A method of operating a display apparatus, the operating method comprising:
receiving a control command for at least one resource of the display device from one or more remote servers;
executing the control command, based on a control policy for the resource; and
transmitting state information of the resource to the remote servers, based on a change in state of the resource as a result of executing the control command.

14. The method of operating the display device of claim 13, wherein:
the resource indicates at least one function provided by the display device, and
the resource comprises at least one of a USB lock/unlock function, a Wi-Fi lock/unlock function, a Bluetooth function, a volume mute function, or a rebooting function.

15. The method of operating the display device of claim 13, wherein:
the receiving of the control command comprises receiving a first control command for a first resource from a first server among the one or more remote servers,
the executing of the control command comprises executing the first control command, based on a control mode for the first resource being a full permission mode, and
the transmitting of the state information of the resource to the remote servers comprises transmitting the state information of the resource to the remote servers, based on a change in state of the first resource as a result of executing the first control command.

16. The method of operating the display device of claim 13, wherein:
the receiving of the control command comprises receiving a second control command for a second resource from a second server among the one or more remote servers,
the executing of the control command comprises:
transmitting a request to approve execution of the second control command to a third server designated as a master server among the one or more remotes servers, based on a control mode for the second resource being a master designation mode;
receiving a response to the request for approval from the third server; and
executing the second control command, based on the response, and
the transmitting of the state information of the resource to the remote servers comprises transmitting the state information of the resource to the remote servers, based on a change in state of the second resource as a result of executing the second control command.

17. The method of operating the display device of claim 16, further comprising:
transmitting information about a failure of execution of the second control command to the second server without executing the second control command, based on a response of rejecting the execution of the second control command being received from the third server.

18. The method of operating the display device of claim 13, wherein:
the receiving of the control command comprises receiving a third control command for a third resource from a fourth server among the one or more remote servers,
the executing of the control command comprises executing the third control command, based on a control mode for the third resource being a security reinforcement mode and on the third control command being a control command to disable the third resource, and
the transmitting of the state information of the resource to the remote servers comprises transmitting the state information of the resource to the remote servers, based on a change in state of the third resource as a result of executing the third control command.

19. The method of operating the display device of claim 18, further comprising:
receiving a fourth control command for the third resource from a fifth server among the one or more remote servers;
transmitting information about a failure of execution of the fourth control command to the fifth server without executing the fourth control command, based on the fourth control command being a control command to enable the third resource and on at least one of control commands corresponding to the remote servers being a control command to disable the third resource;
receiving a fifth control command for the third resource from a sixth server among the one or more remote servers;
executing the fifth control command, based on the fifth control command being a control command to enable the third resource and on all control commands corresponding to the remote servers being control commands to enable the third resource; and
transmitting the state information of the resource to the remote servers, based on a change in state of the third resource as a result of executing the fifth control command.

20. A non-transitory computer-readable recording medium having stored thereon a program which, when executed by at least one processor, comprising processing circuitry, of a display device, individually and/or collectively, causes the display device to perform the method of claim 13.
